(19) United States
(12) Patent Application Publication
(10) Pub. No.: US 2008/0174114 A1
(43) Pub. Date: Jul. 24, 2008

(54) Angle Plate or Corner for Securing Flanges

(76) Inventor: Joseph J. Reitano, Bronx, NY (US)

Correspondence Address: MUSKIN & CUSICK LLC, 30 Vine Street, SUITE 6, Lansdale, PA, 19446, US

(21) Appl. No.: 11/626,337

(22) Filed: Jan. 23, 2007

(51) Int. Cl. F16L 25/00

(52) U.S. Cl. 285/424

(57) ABSTRACT

A corner (also known as angle flange) used to connect ducts together. The corner has an oblong or oval shaped button to help prevent rocking/play/loose movement thus providing a more secure/positive connection. A half moon squaring stop is used so that when the corner is inserted into a flange or frame, the corner cannot be inserted any more than a predetermined distance. Thus, the matching top and the bottom corners can be aligned properly and securely connected.

### BACKGROUND OF THE INVENTION

1. Field of the Invention

The present inventive concept relates to a corner that can be used to secure flanges on ducts and other structural objects.

2. Description of the Related Art

Sheet metal ducts can be connected by providing each corner on each end of the duct to be connected with an angle flange. Angle plates can then be fitted into the respective angle flanges. The ducts are then secured together by using fasteners which connected the angles plates together.

For example, see FIG. 1 of U.S. Pat. No. 5,342,100, which illustrates how two ducts can be connected using angle flanges and angle plates. Other U.S. patents which relate to this art are U.S. Pat. No. 4,466,641 and U.S. Pat. No. 4,542,923. All three of these patents (U.S. Pat. Nos. 5,342,100; 4,466,641; 4,542,923) are incorporated by reference herein in their entireties.

FIG. 1 illustrates a prior art angle plate with round buttons. One disadvantage of the round buttons is that they do not provide enough grip in a flange which could cause rocking of the frame after the corners are installed.

What is needed is an improved angle plate to more firmly connect ducts together which results in a more stable and permanent connection.

### SUMMARY OF THE INVENTION

It is an aspect of the present invention to provide a corner (also known as angle plate) which is an improvement over the prior art.

The above aspects can be obtained by an apparatus that includes (a) a first leg; (b) a second leg connected to the first leg at a substantially right angle; (c) a first oblong shaped button on the first leg extruding on a top side of the corner; and (d) a second oblong shaped button on the second leg extruding on a top side of the corner.

The above aspects can also be obtained by a method that includes (a) providing a first corner, the first corner comprising: (b) a first leg; (c) a second leg connected to the first leg at a substantially right angle; (d) a first oblong shaped button on the first leg extruding on a top side of the corner; (e) a second oblong shaped button on the second leg extruding on a top side of the corner; (f) providing a second corner, the second corner comprising: (g) a first leg; (h) a second leg connected to the first leg at a substantially right angle; (i) a first oblong shaped button on the first leg extruding on a top side of the corner; (j) a second oblong shaped button on the second leg extruding on a top side of the corner; (k) inserting the first leg of the first corner into a first lower flange and inserting the second leg of the first corner into a second lower flange; (1) inserting the first leg of the second corner into a first upper flange and inserting the second leg of the second corner into a second upper flange; and (m) securing the first corner to the second corner, thereby attaching the first lower flange and the second lower flange to the first upper flange and the second upper flange.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is a drawing of a prior art corner;

FIG. 2 is a drawing illustrating a view of a top of a corner, according to an embodiment;

FIG. 3 is a drawing illustrating a view of a bottom of the corner, according to an embodiment;

FIG. 4A is a drawing illustrating a first view of a side of the corner with the top on top, according to an embodiment;

FIG. 4B is a drawing illustrating a second view of a side of the corner with the top on top, according to an embodiment;

FIG. 4C is a drawing illustrating a first view of a side of the corner with the bottom on top, according to an embodiment;

FIG. 4D is a drawing illustrating a second view of a side of the corner with the bottom on top, according to an embodiment;

FIG. 5A is an isometric drawing illustrating a first view of a top of the corner, according to an embodiment;

FIG. 5B is an isometric drawing illustrating a second view of the top of the corner, according to an embodiment;

FIG. 6 is an isometric drawing illustrating a view of the bottom of the corner, according to an embodiment;

FIG. 7A is an isometric drawing of two duct sections connected by a flange and corner system, according to an embodiment;

FIG. 7B is an isometric drawing of a corner inserted into a flange, according to an embodiment; and

FIG. 8 is a schematic drawing of a corner, according to an embodiment.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

The present general inventive concept relates to a corner (also known as angle plate) for use with connected sections of ducts. Each duct section has a flange attached to it, so that each corner inserts into the flange. Then two corners are aligned and connected using any connecting mechanism (e.g., bolts, screws, welding, etc.) in order to connect the two duct sections together.

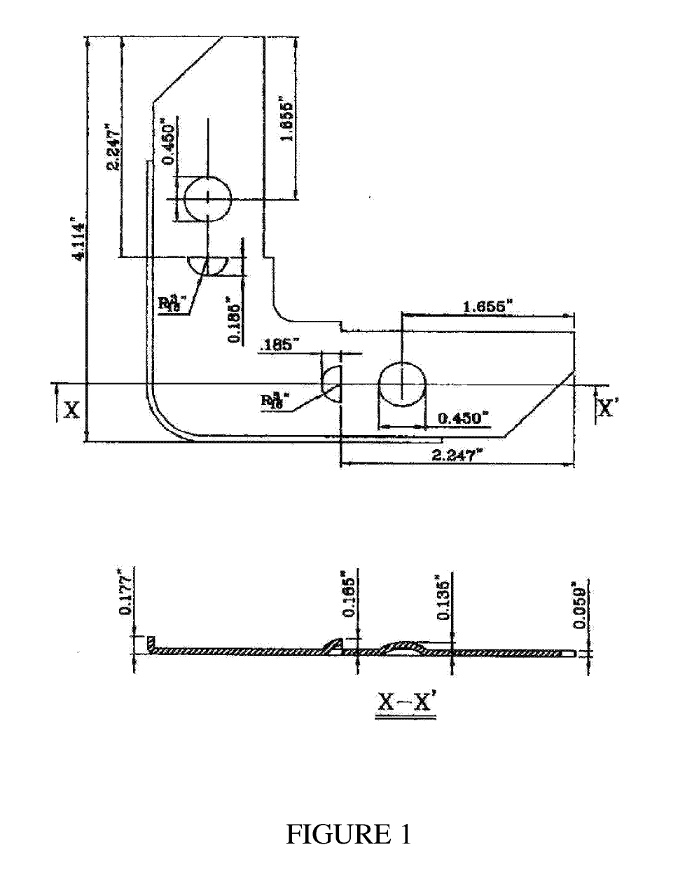

FIG. 1 is a drawing of a prior art corner.

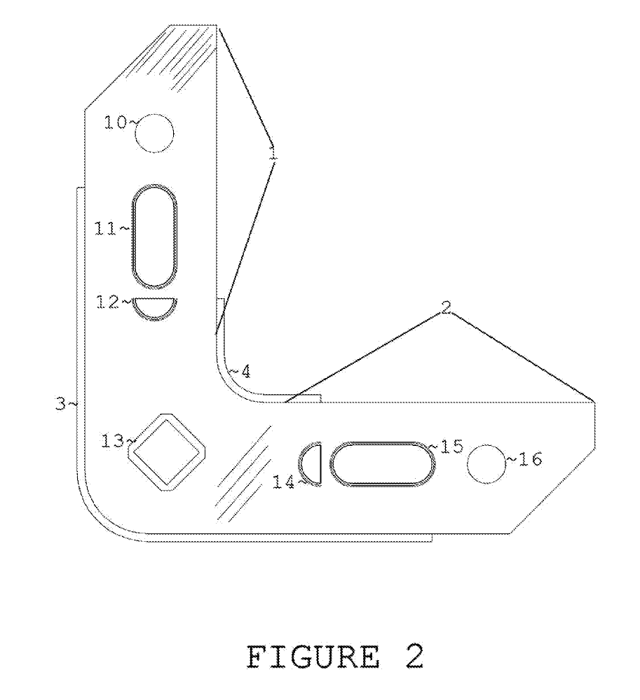

FIG. 2 is a drawing illustrating a view of a top of a corner, according to an embodiment.

A corner is illustrated which has a first leg 1 and a second leg 2. The corner also has an outside ridge 3 and an inside ridge 4. A first hole 10 can be used for bolting the corner through a flange (or angle plate) and to another corner (not pictured). A second hole 16 can be used for the same purpose.

An oblong first button top 11 of a first button is used to make contact with a flange or connector. The first button top 11 extrudes from the rest of a surface of the corner. A first half moon stopper top 12 of a first half moon stopper is used when inserting the first leg 1 into a flange (or connector) so the first leg only goes inside the flange a certain desired distance. The first half moon stopper top 12 extrudes from the rest of the surface of the corner. The first half moon stopper top 12 extrudes a little higher (more) than the first button top 11. This is so that the first button top 11 can fit inside the flange or connector but the first half moon stopper top 12 will not fit inside the flange or connector, thereby preventing the first leg 1 from being inserted any further into the flange or connector.

Note that the first button top 11 is close to the first half moon stopper top 12, or in other words, the first button top is close to the first half moon stopper. The location of the first button top being close to the first half moon stopper aids the connection to the flange since this is the point or area that is important, that is, toward the stop where the corner/frame would set. The distance between the first button (or the first button top 11) and the first half moon stopper (or the first half moon stopper top 12) can be, for example, 0.1 inch, 0.15 inch, 0.2, inch, or range between 0.1 and 0.15, 0.15 and 0.2, 0.1 and 0.2, etc.

An oblong second button top 15 of a second button is used to make contact with a flange or connector. The second button top 15 extrudes from the rest of a surface of the corner. A second half moon stopper top 14 is used when inserting the second leg 2 into a flange (or connector) so the second leg only goes inside the flange a certain desired distance. The second half moon stopper top 14 extrudes from the rest of the surface of the corner. The second half moon stopper top 14 extrudes a little higher (more) than the second button top 15. This is so that the second button top 15 can fit inside the flange or connector but the second half moon stopper top 14 will not fit into the flange or connector, thereby preventing the second leg 2 from being inserted any further into the flange or connector.

Note that the second button top 15 is close to the second half moon stopper top 14, or in other words, the second button top is close to the second half moon stopper. The location of the second button top being close to the second half moon stopper aids the connection to the flange since this is the point or area that is important, that is, toward the stop where the corner/frame would set. The distance between the second button (or the second button top 11) and the second half moon stopper (or the second half moon stopper top 12) can be, for example, 0.1 inch, 0.15 inch, 0.2, inch, or range between 0.1 and 0.15, 0.15 and 0.2, 0.1 and 0.2, etc.

A square knockout top 13 of a square knockout is located in a middle section of the corner and is designed with steel pushed towards the top of the corner so that a ⅜″ carriage bolt (or other fastener) can set into the square knockout to eliminate slippage while securing the frames together. Extra steel can reinforce the carriage bolt as the frames were pulled tight towards each other (to avoid bending the corner at the point of stress) can stiffen the corner for added strength. The square knockout can have corners of the square directed toward a squaring stop, as this is believed to aid the field installer by providing a more ergonomic position for connecting frames.

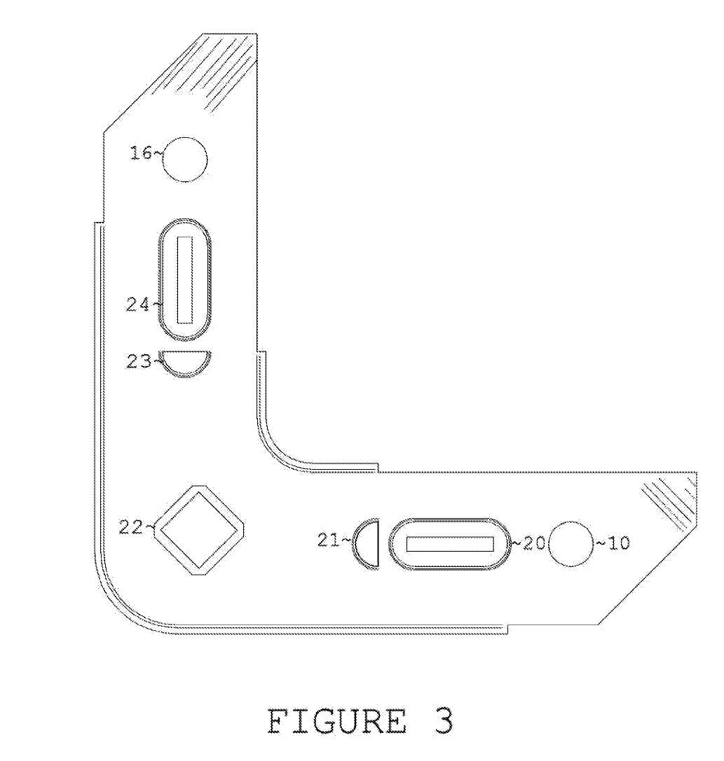

FIG. 3 is a drawing illustrating a view of a bottom of the corner, according to an embodiment.

An oblong first button bottom 20 of the first button is recessed. A first half moon stopper bottom 21 of the first half moon stopper is recessed. An oblong second button bottom 24 of the second button is recessed. A second half moon stopper bottom 23 of the second half moon stopper is recessed. A square knockout bottom 22 of the square knockout is also shown.

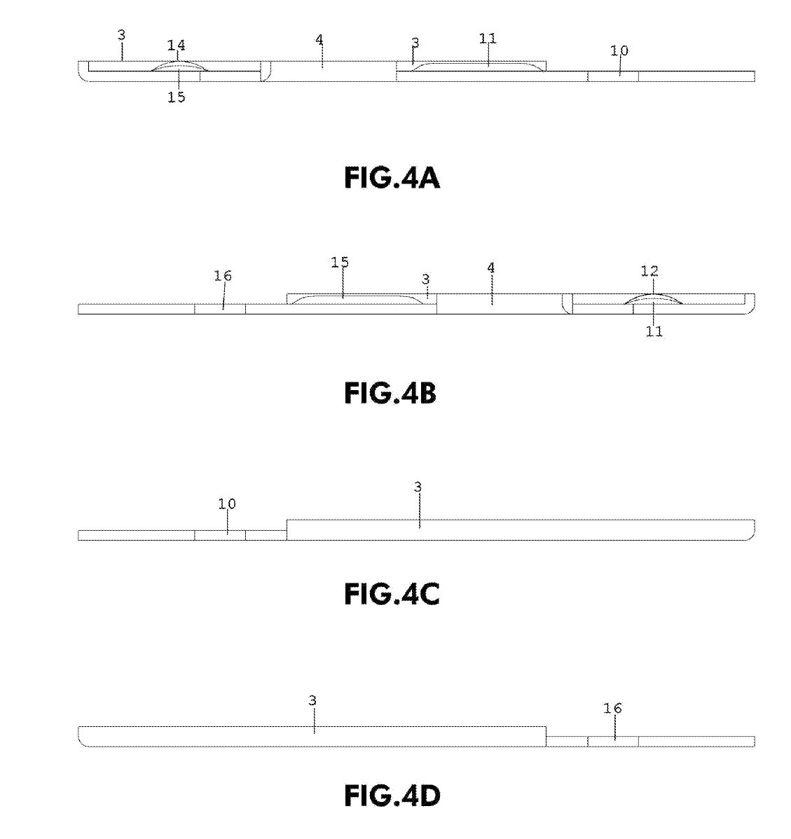

FIG. 4A is a drawing illustrating a first view of a side of the corner with the top on top, according to an embodiment.

The second half moon stopper top 14 is slightly higher than the oblong second button top 15. The outside ridge 3 and the inside ridge 4 can be used to insert/guide the corner into a flange. The outside ridge 3 is visible behind the oblong first button top 11. The first hole 10 is not directly visible in this view.

FIG. 4B is a drawing illustrating a second view of a side of the corner with the top on top, according to an embodiment.

The outside ridge 3 is visible behind the oblong second button top 15. The inside ridge 4 is between the first leg and the second leg. The first half moon stopper top 12 is slightly higher than the oblong first button top 11. The second hole 16 is not directly visible in this view.

FIG. 4C is a drawing illustrating a first view of a side of the corner with the bottom on top, according to an embodiment.

The first hole 10 is not directly visible in this view. The outside ridge 3 forms a perimeter around the corner.

FIG. 4D is a drawing illustrating a second view of a side of the corner with the bottom on top, according to an embodiment.

The second hole 16 is not directly visible in this view. The outside ridge 3 forms a perimeter around the corner.

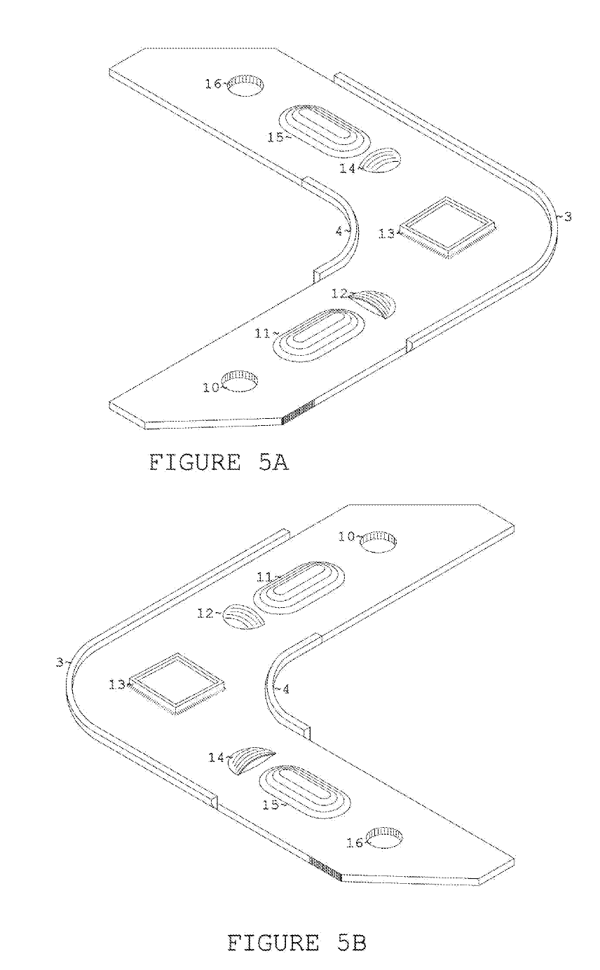

FIG. 5A is an isometric drawing illustrating a first view of a top of the corner, according to an embodiment. FIG. 5B is an isometric drawing illustrating a second view of the top of the corner, according to an embodiment.

Referring to FIG. 5A and FIG. 5B, the oblong first button top 11, the first half moon stopper top 12, the square knockout top 13, the second half moon stopper top 14, and the oblong second button top 15, and outside ridge 3, and the inside ridge 4, all extrude from the surface of the corner.

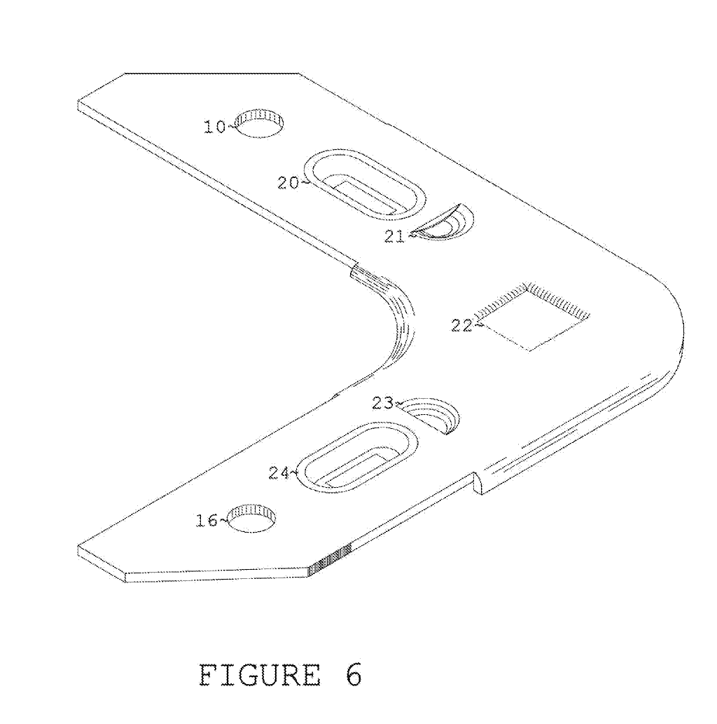

FIG. 6 is an isometric drawing illustrating a view of the bottom of the corner, according to an embodiment.

An oblong first button bottom 20 of the first button is recessed. A first half moon stopper bottom 21 of the first half moon stopper is recessed. An oblong second button bottom 24 of the second button is recessed. A second half moon stopper bottom 23 of the second half moon stopper is recessed. A square knockout bottom 22 of the square knockout is also shown.

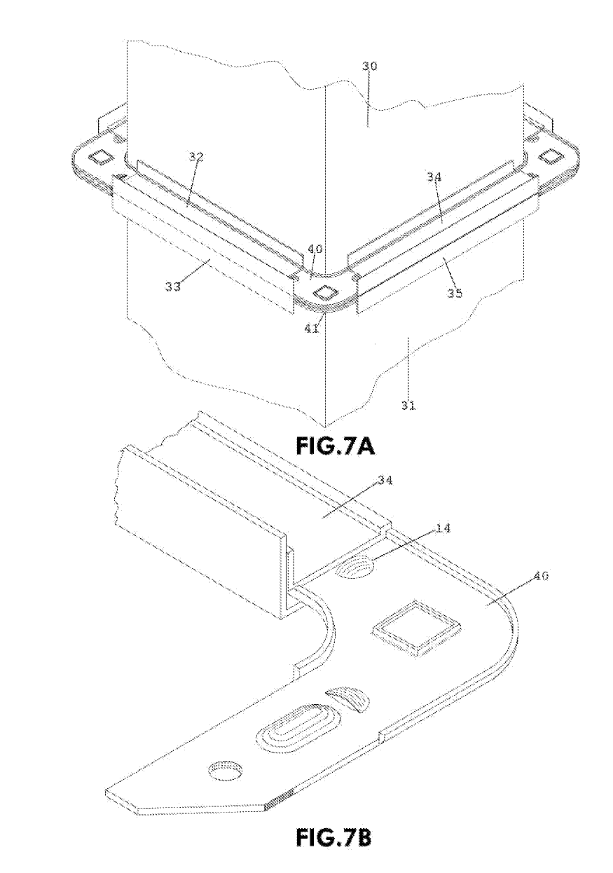

FIG. 7A is an isometric drawing of two duct sections connected by a flange and corner system, according to an embodiment.

An upper duct 30 and a lower duct 31 are connected. An upper corner 40 is inserted into a first upper flange 32 and a second upper flange 34. A lower corner 41 is inserted into a first lower flange 33 and a second lower flange 35. The upper corner 40 and the lower corner 41 can be attached together by any known attachment mechanism, such as a bolt, screw, weld, etc.

FIG. 7B is an isometric drawing of a corner inserted into a flange, according to an embodiment.

The upper corner 40 is inserted into the second upper flange 34. The second half moon stopper top 14 prevents the upper corner 40 from being inserted any further into the second upper flange 34. This helps to ensure proper alignment with the lower corner 41 when these two corners are attached.

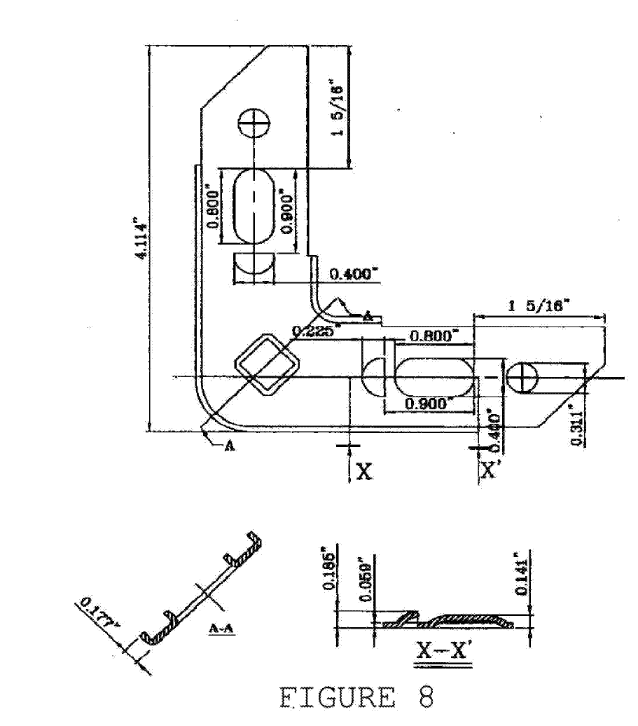

FIG. 8 is a schematic drawing of a corner, according to an embodiment.

Please note that the distances, sizes, measurements, etc., illustrated are merely exemplary and the inventive concept can be achieved with other parameters as well.

Note that and end of each half moon is 0.1″ from a closest point of a closest oval button. Having the half moon close to the oval button can help stability. The end of the half moon can be less than (or less than or equal to) 0.2″ (although not required to be) from a closest point of a closest oval, or 0.15″, or 0.1″, or 0.05″, or the distance can be described to fall into a range, such as 0.05″ to any of these values (e.g., 0.05″ to 0.15″). The oval button is 0.8″ long and 0.4″ wide. Thus, a length of the oval button can be twice its width, or the length of the oval button can be greater than (or greater than or equal to) twice its width, (or 1.5 times or 2 times or 2.5 times, or 3 times, etc.) The length of the oval button can also be described to fall into a range, such as 1.5 to 2.5 times its width, or 2 to 3 times its width, etc.

The corner design illustrated in FIG. 8 (and other figures) can be compatible with common slip-on flanges such as DUCTMATE-35, WARD ‘J’ Connect and NEXUS. Of course the features illustrated herein can also be used for corners which can be compatible (e.g., sized and shaped properly in order to slide properly inside a flange) with other makes/models of flanges as well.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A corner, the corner comprising:
a first leg;
a second leg connected to the first leg at a substantially right angle;
a first oblong shaped button on the first leg extruding on a top side of the corner; and
a second oblong shaped button on the second leg extruding on a top side of the corner.

2. The corner as recited in claim 1, wherein the first oblong shaped button is elongated in a direction parallel to the first leg and the second oblong shaped button is elongated in a direction parallel to the second leg.

3. The corner as recited in claim 1, further comprising:
a first half moon stopper on the first leg located further from an end of the first leg than the first oblong shaped button; and
a second half moon stopper on the second leg located further from an end of the second leg than the second oblong shaped button.

4. The corner as recited in claim 2, further comprising:
a first half moon stopper on the first leg located further from an end of the first leg than the first oblong shaped button; and
a second half moon stopper on the second leg located further from an end of the second leg than the second oblong shaped button.

5. The corner as recited in claim 4, wherein a distance between the first half moon stopper and the first oblong shaped button is less than 0.2 inches.

6. The corner as recited in claim 4, wherein a distance between the first half moon stopper and the first oblong shaped button is less than 0.15 inches.

7. The corner as recited in claim 4, wherein a distance between the first half moon stopper and the first oblong shaped button is 0.1 inches.

8. The corner as recited in claim 1, wherein the first oblong shaped button is substantially 0.9 inches in length.

9. The corner as recited in claim 8, wherein the second oblong shaped button is substantially 0.9 inches in length.

10. The corner as recited in claim 1, wherein a length of the first oblong shaped button is greater than or equal to twice a width of the first oblong shaped button.

11. The corner as recited in claim 2, wherein a length of the first oblong shaped button is greater than or equal to twice a width of the first oblong shaped button.

12. The corner as recited in claim 11, wherein the length of the oblong shaped button is approximately 0.8 inches and the width of the oblong shaped button is approximately 0.4 inches.

13. The corner as recited in claim 2, further comprising a square knockout on a middle part of the corner.

14. A method to connect duct sections, the method comprising:
providing a first corner, the first corner comprising:
a first leg;
a second leg connected to the first leg at a substantially right angle;
a first oblong shaped button on the first leg extruding on a top side of the corner;
a second oblong shaped button on the second leg extruding on a top side of the corner.
providing a second corner, the second corner comprising:
a first leg;
a second leg connected to the first leg at a substantially right angle;
a first oblong shaped button on the first leg extruding on a top side of the corner;
a second oblong shaped button on the second leg extruding on a top side of the corner;
inserting the first leg of the first corner into a first lower flange and inserting the second leg of the first corner into a second lower flange;
inserting the first leg of the second corner into a first upper flange and inserting the second leg of the second corner into a second upper flange; and
securing the first corner to the second corner, thereby attaching the first lower flange and the second lower flange to the first upper flange and the second upper flange.

15. The method as recited in claim 14, wherein the first oblong shaped button of the first corner is elongated in a direction parallel to the first leg of the first corner and the second oblong shaped button of the first corner is elongated in a direction parallel to the second leg of the first corner.

16. The method as recited in claim 14, wherein the first corner further comprises:
a first half moon stopper on the first leg of the first corner located further from an end of the first leg than the first oblong shaped button; and
a second half moon stopper on the second leg of the first corner located further from an end of the second leg than the second oblong shaped button.

17. The method as recited in claim 15, wherein the first corner further comprises:
a first half moon stopper on the first leg of the first corner located further from an end of the first leg than the first oblong shaped button; and
a second half moon stopper on the second leg of the first corner located further from an end of the second leg than the second oblong shaped button.

18. The method as recited in claim 14, wherein the first corner further comprises a first square knockout on a middle part of the first corner, and the second corner further comprises a second square knockout on a middle part of the second corner.

19. The method as recited in claim 14, wherein the first corner and the second corner are secured by a fastener through the first square knockout and the second square knockout.

20. The method as recited in claim 19, wherein the fastener is a bolt.
